(19) United States
(12) Patent Application Publication
(10) Pub. No.: US 2012/0291103 A1
(43) Pub. Date: Nov. 15, 2012

(54) PERMISSION-BASED ADMINISTRATIVE CONTROLS

(75) Inventor: Gabriel A. Cohen, Alameda, CA (US)

(73) Assignee: GOOGLE INC., Mountain View, CA (US)

(21) Appl. No.: 13/250,631

(22) Filed: Sep. 30, 2011

Related U.S. Application Data
(63) Continuation of application No. 13/112,097, filed on May 20, 2011.
(60) Provisional application No. 61/483,959, filed on May 9, 2011.

(51) Int. Cl. G06F 21/22; G06F 17/30

(52) U.S. Cl. 726/4

(57) ABSTRACT

Methods, systems, and apparatus, including computer programs encoded on a computer storage medium, for implementing permission-based administrative controls. In one aspect, a method includes receiving an administrator-defined pairing that identifies a permission and one or more applications, and receiving a request from a requesting application to perform one or more operations that are associated with the permission. The method also includes determining whether the requesting application is identified in the pairing, and selectively allowing the requesting application to perform the operations based on determining whether the requesting application is identified in the pairing.

### CROSS-REFERENCE TO RELATED APPLICATION

This application is a continuation of U.S. application Ser. No. 13/112,097, filed May 20, 2011, which is a non-provisional application of U.S. Pat. App. No. 61/483,959, filed May 9, 2011, which is incorporated herein by reference.

### FIELD

The present disclosure generally relates to the management of access to information technology (IT) assets.

### BACKGROUND

Among their many responsibilities, IT administrators have the task of managing and securing access to an organization's information. To fulfill this obligation, IT administrators manage accounts and passwords for their users, and manage their users' ability to access the organization's various IT systems and data repositories.

One source of risk to the security of IT assets arises when an employee uses personal hardware or software to access the organization's hardware or software systems. An example class of such hardware is smartphones. Specifically, and rather than carry a personal phone to perform personal functions and a corporate phone to perform corporate functions and access corporate data, some users use their personally-owned smartphones as “dual use” personal/business phones, that serve both personal and work needs.

To reduce the risk of exposure to malicious hardware and software, or exposure of their data through malicious exploitation of otherwise benign hardware and software, companies may allow their employees to access corporate data with their smartphones or other personally owned computing devices under predetermined conditions. For example, companies may make sure that their employee's devices have secure access codes, encrypted file systems, and trusted application sandboxes in place before access to the organization's data is granted. Alternatively, IT administrators may prescribe approved configurations of hardware and software that have been tested for use in accessing the organization's data.

As employee-owned, dual use devices become more common, the restrictions placed on these devices by traditional blacklists and whitelists may become too coarse. For example, in cases in which an IT department uses an application “allow” list to define applications that may be installed on a device, the end user may be blocked from installing applications of their own choosing, even if those applications do not access any corporate data at all. Employees may find that such a framework may hamstring the usefulness of a device, particularly when the employee discovers that upgraded hardware or software that has not yet been approved is not permitted on a device that has access to an organization's IT resources.

### SUMMARY

In general, this document describes systems and methods for selectively managing which of the functions of a mobile device are to be made available, or are to be blocked, for selected applications that may operate on the mobile device. Specifically, an IT administrator may publish a policy to devices that access an organization's data, including employee's personal devices when they are provisioned for business use.

The policy may specify which applications that are installed or are executing on the mobile device may access, or may not access, data, functions or operations that are associated with mobile device permissions, such as a permission to access calendar data or contact data. When an application seeks to access a function associated with a particular permission, a security application or module determines whether the policy allows or disallows such access before allowing the function to be performed. In the situation where a mobile device is associated with multiple user accounts, the policy (or particular restrictions defined by the policy) may apply to all user accounts associated with the mobile device, or to a particular subset of the user accounts.

As used by this disclosure, a “permission” is a restriction that limits or otherwise governs access to a part of the code, to data, or to functionality on a device. Permissions, which may be defined by an operating system of the device, may restrict read or write access to particular data, such as a contact database or an email database or, for example, may limit access to device hardware resources or communication resources. A permission may, for example, govern an ability of a mobile device to access data generated by a particular hardware module, to operate in a “roaming” mode, or to access a 4G network.

Permissions are imposed to protect critical data and code that could be misused to distort or damage the user experience. Permissions are identified by a unique name or label, which often suggests the function that is restricted by the permission, and specify or define an association with the restricted code, data, or function.

In general, another aspect of the subject matter described in this specification may be embodied in methods that include the actions of receiving, from over a network and by a security application on a mobile device, a pairing that identifies a permission and one or more applications, and generating, by the security application, a data structure for the permission based on the pairing, wherein the data structure for the permission identifies the one or more applications. The method also includes receiving, by the security application, a request from a requesting application to perform one or more operations that are associated with the permission, determining, by the security application, whether the requesting application is identified in the data structure, and selectively allowing, by the security application, the requesting application to perform the operations based on determining whether the requesting application is identified in the data structure.

In general, another aspect of the subject matter described in this specification may be embodied in methods that include the actions of receiving an administrator-defined pairing that identifies a permission and one or more applications, receiving a request from a requesting application to perform one or more operations that are associated with the permission, determining whether the requesting application is identified in the pairing, and selectively allowing the requesting application to perform the operations based on determining whether the requesting application is identified in the pairing.

In general, another aspect of the subject matter described in this specification may be embodied in methods that include the actions of receiving, by an administrator server, data identifying a mobile device or a user of a mobile device, and using, by the administrator server, the data to select a security policy, from among multiple security policies, each security policy specifying one or more mobile device permissions and, for each mobile device permission, one or more applications. The method includes communicating, by the administrator server, the selected security policy to the mobile device.

In general, another aspect of the subject matter described in this specification may be embodied in methods that include the actions of receiving a request from a requesting application to perform one or more operations that are associated with a permission, and accessing data usable to determine whether the requesting application is authorized to perform the one or more operations, the data based on one or more security policies defined by an administrator of the computer. The method also includes based on the data, determining whether the requesting application is authorized to perform the one or more operations, and if the requesting application is authorized to perform the one or more operations, allowing the requesting application to perform the one or more operations.

Other embodiments of these aspects include corresponding systems, apparatus, and computer programs, configured to perform the actions of the methods, encoded on computer storage devices.

In general, another aspect of the subject matter described in this specification may be embodied in a device, such as a mobile telephone, that includes and a storage medium configured to store a whitelist or blacklist for a particular permission, and store a permission manifest that identifies one or more functions that are associated with the particular permission. The device also includes a request module configured to generate a request to access one or more of the functions that are associated with the particular permission, and a security module configured to determine, using the permission manifest, that the one or more functions to which the request module requests access are associated with the particular permission, determine whether the request module is identified in the whitelist or blacklist for the particular permission, and allow or disallow the request based on determining whether the request module is identified in the whitelist or blacklist for the particular permission.

These and other embodiments can each optionally include one or more of the following features. For example, the data structure comprises a whitelist or a blacklist; the permission is defined by an operating system of the mobile device; one or more of the operations comprises an operation to access a particular process on the mobile device, an operation to access particular functionality of the mobile device, or an operation to access particular data stored on the mobile device; the pairing is received over the network from a corporate IT server or from a vendor associated with the requesting application; the pairing identifies the one or more applications by package name, application type, cryptographic signature, vendor name, and/or market-provided certification indicia; the data structure is generated in part using crowdsourced data.

In additional examples, selectively allowing the requesting application to perform the operations comprises allowing the requesting application to perform the operations based on determining that the requesting application is identified in the data structure; selectively allowing the requesting application to perform the operations comprises disallowing the requesting application from performing the operations based on determining that the requesting application is not identified in the data structure; and/or selectively allowing the requesting application to perform the operations comprises transmitting, by the security application, a request to permit the requesting application to perform the operations based on determining that the requesting application is not identified in the data structure, receiving, by the security application, a response to the request, and selectively allowing the requesting application to perform the operations based on the response;

In other examples, selectively allowing the requesting application to perform the operations comprises uninstalling the requesting application based on determining that the requesting application is not identified in the data structure; the network interface is configured to receive the whitelist or blacklist from a corporate server; allowing or disallowing the request comprises allowing the request based on determining that the based on determining whether the request module is identified in the whitelist or is not identified in the blacklist for the particular permission; allowing or disallowing the request comprises disallowing the request based on determining that the based on determining whether the request module is not identified in the whitelist or is identified in the blacklist for the particular permission; and/or the pairing comprises a whitelist, and the one or more applications comprise applications that are authorized to perform one or more operations that are associated with the permission.

In further examples, determining whether the requesting application is identified in the pairing comprises selecting the whitelist that identifies the permission, from among multiple whitelists stored on the mobile device that identify various permissions; the pairing comprises a blacklist, and the one or more applications comprise applications that are not authorized to perform one or more operations that are associated with the permission; the pairing further identifies a particular user account, and determining whether the requested application is identified in the pairing comprises determining that the particular user account is currently active, and selecting the pairing, from among multiple pairings that each identify a different user account, based on determining that the particular user account is currently active. The process includes receiving the data, wherein the data identifies the permission and the requesting application; the data is received over a network from a different computer associated with the administrator; and/or the security policies are defined by the administrator of the computer, on a different computer.

The systems and techniques described here may provide one or more of the following advantages. For instance, a system can restrict access to corporate data on an permission-by-permission, an application-by-application basis, and optionally an account-by-account basis, without overly restricting the mobile device's access to the rich marketplace of applications that are available for installation and use.

The details of one or more implementations are set forth in the accompanying drawings and the description below. Other features and advantages will be apparent from the description and drawings, and from the claims.

### DESCRIPTION OF DRAWINGS

FIG. 1 is a schematic diagram that shows an example system that implements permission-based administrative controls.

FIG. 2 is a flow chart that shows and example process for controlling access to an information asset.

FIG. 3 is a timeline diagram that shows example interactions among systems for controlling access to information assets.

FIG. 4 is a block diagram of computing devices.

In the drawings, like reference numbers represent corresponding parts throughout.

### DETAILED DESCRIPTION

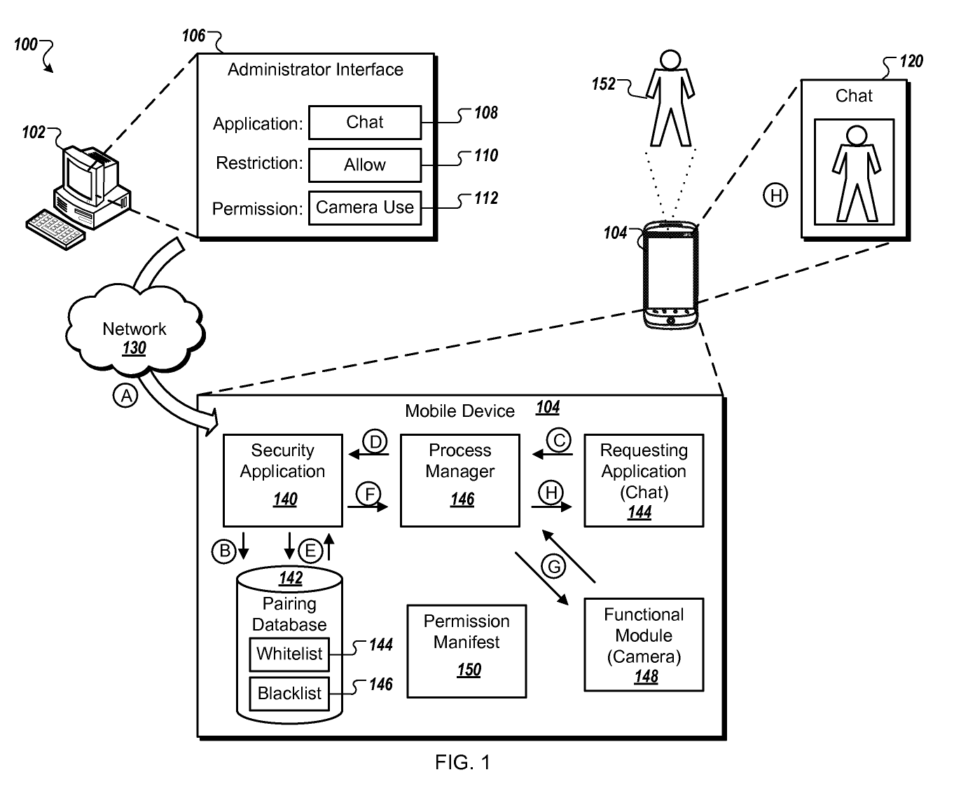

FIG. 1 is a schematic diagram that shows an example system 100 that implements permission-based administrative controls. The system 100 includes an administrator terminal 102 and a mobile device 104 that are connected by a network 130

The terminal 102 is a computer device that provides an administrator interface 106 for use by an employee that manages IT resources on behalf of an organization, e.g., an IT administrator. The network 130 is a wired or wireless private network, e.g., a corporate local area network or intranet, a public network, e.g., the Internet, a cellular data network, or any other appropriate type of computer network.

The mobile device 104 is a computing device that is used by the same or a different employee of the organization, and can be a smartphone, a traditional cellular telephone, a personal computer, a tablet computer, an e-book reader, a music player, or any other appropriate type of computing device. The mobile device 104 may be a dual use device, used by an owner of the device to serve both business and personal needs.

In general, the administrator interface 106 allows the IT administrator to configure settings that can at least partly determine the applications, hardware and software functions, and corporate resources that applications on the mobile device 104 are permitted to access. The IT administrator can use the administrator interface 106 to create a policy that pairs permissions and applications, and/or that specifies a particular restriction for paired permissions and applications. A policy may restrict access to corporate data on an permission-by-permission and application-by-application basis, without overly restricting the mobile device's access to the rich marketplace of applications that are available for installation and use.

In one example, a policy may specify a pairing such as {contacts permission=all applications} to allow all applications on the mobile device 104 to access functionality associated with a “contacts” permission; may specify a pairing such as {email permission=application ABC} to only allow an application identified by the identifier “ABC” to access functionality associated with an “email” permission; or may specify a pairing such as {camera permission=no application} to prevent all applications from accessing functionality associated with a “camera” permission. Such a framework allows applications that may require access to restricted permissions to be installed, but only allows such applications to access functionality associated with permissions with which they are paired, or with unrestricted permissions, e.g., to access non-corporate account data.

In FIG. 1, the administrator interface 106 provides an application input control 108, a restriction input control 110, and a permission input control 112. During state (a), the IT administrator enters data into the application input control 108 to identify an application that the mobile device 104 can run under permission-based administrative control. The application may be identified by package name (e.g., “Google Chrome,” “Google Earth”), application type or category (e.g., “web browser,” “game”), label (“reviewed,” “All ages”), grouping (“Microsoft Office suite”); cryptographic signature (e.g., “RSA,” “128-bit encryption”), vendor name (e.g., “Google”), heuristics, or market-provided certification indicia (e.g., “4 stars or above,” “Source: Google Apps Marketplace”). In FIG. 1, the identified application is a “chat” application 144.

Next, the IT administrator enters data into the restriction input control 110 to identify the type of restriction that is to be associated with the application identified in the application input control 108. In some implementations, the restriction options may include “restrict,” “block,” “permit,” or “allow.” A “restrict” or “block” selection may result in an application being placed on a blacklist for an identified permission, or in the application being removed or omitted from a whitelist for the identified permission. A “permit” or “allow” selection may result in the application being placed on a whitelist for an identified permission, or in the application being removed or omitted from a whitelist for the identified permission. In FIG. 1, the IT administrator has selected to “allow” the “chat” application 144.

In other implementations, a restriction option is not specified by the IT administrator, and a default setting or a setting that is inherent to the type of permission is used. The IT administrator may instead specify, e.g., through a “seek approval” selection, that approval for the “chat” application 144 to perform functionality associated with a permission is to be sought at run-time. By this restriction, when the “chat” application 144 performs or seeks to perform functionality associated with a permission, a request message is sent across the network 130 to the administrator terminal 102, and the IT administrator is presented with the option of allowing or disallowing the application from performing the functionality. The IT administrator selects an appropriate option, and an approval message or disapproval message is sent across the network 130 to the mobile device 104, and the mobile device 104 allows or disallows the “chat” application 144 from performing the functionality associated with the permission based on the type or content of the received message.

Alternatively, the IT administrator may specify, e.g., through a “notify” selection, that the IT administrator is to be notified when the “chat” application 144 performs or seeks to perform the functionality associated with a permission. By this restriction, when the “chat” application 144 performs or seeks to perform functionality associated with a permission, a notification is sent across the network 130 to the administrator terminal 102, and the IT administrator is presented with information identifying the application that is performing or seeking to perform the functionality. The information may also specify a time, date and/or location, may identify the mobile device 104 or the user of the mobile device 104, and/or may specify a user account on the mobile device 104 for which any restrictions are intended to apply.

The IT administrator enters a permission name into the permission input control 112 to specify the permission whose associated functionality, data, operations, or resources the identified application is permitted to access, or is restricted from accessing. In FIG. 1, the IT administrator has identified the “camera” permission, thereby selecting to “allow” the use of functions associated with the “camera” permission from within the “chat” application.

The permissions, and the code, data, or functionality associated with each permission, may be predefined by an application, operating system, or file system of the mobile device 104. In other examples, the IT administrator may manually configure permissions associated with the use of data repositories stored on or accessed by the mobile device 104, user device functions (e.g., microphone, location awareness, wireless connectivity), device capabilities (e.g., text messaging, data connectivity, cellular roaming), or other application or mobile device 104 features. The IT administrator may use the administrator interface 106 to manually configure such permissions.

The administrator terminal 102 transmits data identifying the specified application, restriction, and permission to the mobile device 104 through a network 130. If the mobile device 104 applies a default restriction, the data transmitted from the administrator terminal 102 need only identify a paired application and permission (referred to by this disclosure as a “pairing”). When the data is received by the mobile device 104, the permissions are communicated to a security application 140.

During state (b), the security application 140 stores the permissions in a pairing database 142. The pairing database includes data structures such as whitelist 144 and/or a blacklist 146 for one or more permissions that are identified in a permission manifest 150. In general, the whitelist 144 identifies applications and the permissions whose associated functionality each respective application is permitted to access, and blacklist 146 identifies applications and the permissions whose associated functionality each respective application is not permitted to access.

During state (c), a requesting application 144, i.e., the “chat” application, sends a request to a process manager 146 to request access to a functional module 148, i.e., a camera. The process manager 146 manages applications' access to processes, features, and functions of the mobile device.

During state (d), the process manager 146 determines that use of the functional module 148 is governed by a particular permission, and sends a request to allow the requesting application 144 to access the particular permission, to the security application 140. The process manager 146 may consult the permission manifest 150 to identify the particular permissions that are associated with a given device functionality or resource. In some implementations, the request can include information identifying the requesting application 144, and information identifying the functional module 148 or the particular permission associated with the functional module 148.

During state (e), the security application 140 requests whitelist 144 and blacklist 146 information from the pairing database 142 and, in line with the information entered by the IT administrator through the administrator interface 106, determines that the requesting application 144 is allowed to access the functional module 148. During state (f), the security application 140 responds to the process manager's 146 permission request, indicating that the requested function is allowed to be accessed by the requesting application 144.

During state (g), the process manager 146 responds to the requesting application's 144 request by allowing or restricting the requesting application 144 from accessing the functional module 148. In FIG. 1, the use of the functional module 148 is allowed by the process manager 146, enabling a user of the mobile device 104 to take a picture of an object 152 through the “chat” application 144. As a result, the chat application 144 displays a chat interface 120 on the mobile device 104, including a picture of the object 152.

In some implementations, the process manager 146 may act as a firewall between the requesting application 146 and the functional module 148. For example, rather than allow applications to access functional modules directly, the process manager 146 may expose application programming interfaces for some or all of the mobile device's 104 functional modules in such a way that the functional modules may be unaware of the presence and actions of the process manager 146.

In some implementations, some of the described functions may be provided by one or more server devices. For example, the security application 140 and the pairing database 142 may be located on a corporate information technology server apart from the mobile device. When the process manager 146 receives a function request from the requesting application 144, the process manager 146 may access the security application through the network 130 in order to grant or deny access to the functional module 148.

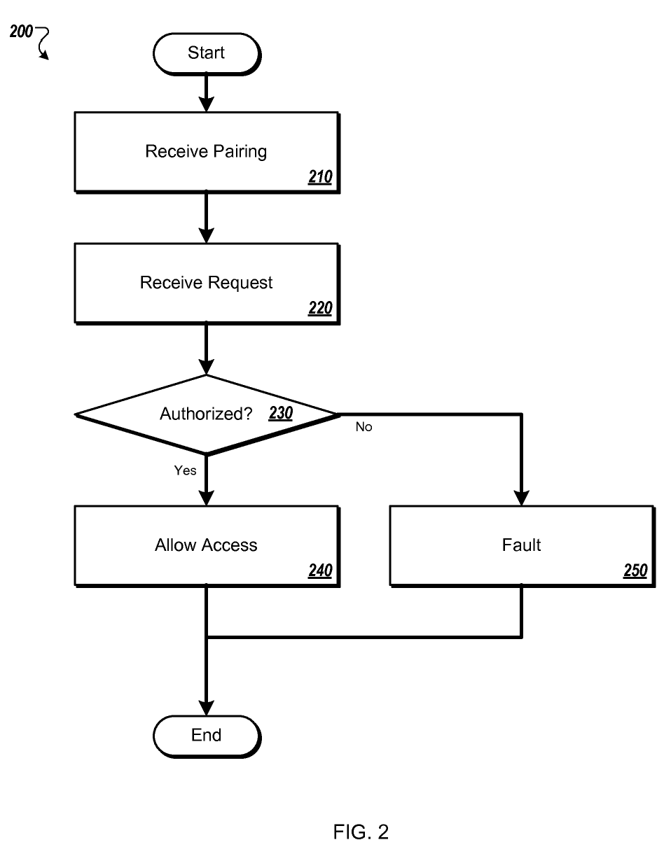

FIG. 2 is a flow chart that shows and example process 200 for controlling access to an information asset. In some implementations, the process 200 may be performed by the mobile device 104 of FIG. 1.

The process 200 begins at step 210 where a security application on a mobile device receives data, e.g., a pairing, that identifies a permission and one or more applications, and optionally identifies a type of restriction or access privilege to apply to the pairing. The data may specify a user account to which any restrictions defined by the pairing are intended to apply. The security application 140 may receive data from a corporate server when the mobile device is provisioned for use with a corporate network, or from a vendor associated with a particular application.

In addition to identifying a permission, one or more applications, and a restriction or access privilege, the received data may also specify a different permission and a condition. For instance, the data may specify that an application is permitted or not permitted to access functionality associated with a first permission, depending upon whether the application is permitted or not permitted to access functionality associated with a second permission. For instance, an application may be authorized to access an Internet permission, but only if the application does not have access to the Read Contacts permission.

The permission may be predefined in a permission manifest that is specified by an operating system of the mobile device. Each permission may include a label, and may identify code, data, or functionality that is associated with the permission. Table 1 lists several example permissions that may be defined by a particular operating system.

TABLE 1
Example permission labels and associated code, data or functionality

| Permission Label or Name | Code, Data or Functionality Associated with the Permission |
|---|---|
| ACCESS_CHECKIN_PROPERTIES | Allows read/write access to the “properties” table in the |
| | check in database, to change values that get uploaded. |
| ACCESS_COARSE_LOCATION | Allows an application to access coarse (e.g., Cell-ID, WiFi) |
| | location |
| ACCESS_FINE_LOCATION | Allows an application to access fine (e.g., GPS) location |
| ACCESS_LOCATION_EXTRA_COMMANDS | Allows an application to access extra location provider |
| | commands |
| ACCESS_MOCK_LOCATION | Allows an application to create mock location providers for |
| | testing |
| ACCESS_NETWORK_STATE | Allows applications to access information about networks |
| ACCESS_SURFACE_FLINGER | Allows an application to use a window compositor's low |
| | level features |
| ACCESS_WIFI_STATE | Allows applications to access information about Wi-Fi |
| | networks |
| ACCOUNT_MANAGER | Allows applications to call into account authenticators. |
| AUTHENTICATE_ACCOUNTS | Allows an application to act as an account authenticators |
| | for an account manager |
| BATTERY_STATS | Allows an application to collect battery statistics |
| BIND_APPWIDGET | Allows an application to tell a widget service which |
| | application can access widget's data. |
| BIND_DEVICE_ADMIN | Used by device administration receiver, to ensure that only |
| | the system can interact with it. |
| BIND_INPUT_METHOD | Used by an input method service, to ensure that only the |
| | system can bind to it. |
| BIND_REMOTEVIEWS | Used by a remove views service, to ensure that only the |
| | system can bind to it. |
| BIND_WALLPAPER | Used by a wallpaper service, to ensure that only the |
| | system can bind to it. |
| BLUETOOTH | Allows applications to connect to paired Bluetooth devices |
| BLUETOOTH_ADMIN | Allows applications to discover and pair Bluetooth devices |
| BRICK | Used to disable the device. |
| BROADCAST_PACKAGE_REMOVED | Allows an application to broadcast a notification that an |
| | application package has been removed. |
| BROADCAST_SMS | Allows an application to broadcast an SMS receipt |
| | notification |
| BROADCAST_STICKY | Allows an application to broadcast sticky intents. |
| BROADCAST_WAP_PUSH | Allows an application to broadcast a WAP PUSH receipt |
| | notification |
| CALL_PHONE | Allows an application to initiate a phone call without going |
| | through the Dialer user interface for the user to confirm the |
| | call being placed. |
| CALL_PRIVILEGED | Allows an application to call any phone number, including |
| | emergency numbers, without going through the Dialer |
| | user interface for the user to confirm the call being placed. |
| CAMERA | Used to access the camera device. |
| CHANGE_COMPONENT_ENABLED_STATE | Allows an application to change whether an application |
| | component (other than its own) is enabled or not. |
| CHANGE_CONFIGURATION | Allows an application to modify the current configuration, |
| | such as locale. |
| CHANGE_NETWORK_STATE | Allows applications to change network connectivity state |
| CHANGE_WIFI_MULTICAST_STATE | Allows applications to enter Wi-Fi Multicast mode |
| CHANGE_WIFI_STATE | Allows applications to change Wi-Fi connectivity state |
| CLEAR_APP_CACHE | Allows an application to clear the caches of all installed |
| | applications on the device. |
| CLEAR_APP_USER_DATA | Allows an application to clear user data |
| CONTROL_LOCATION_UPDATES | Allows enabling/disabling location update notifications |
| | from the radio. |
| DELETE_CACHE_FILES | Allows an application to delete cache files. |
| DELETE_PACKAGES | Allows an application to delete packages. |
| DEVICE_POWER | Allows low-level access to power management |
| DIAGNOSTIC | Allows applications to RW to diagnostic resources. |
| DISABLE_KEYGUARD | Allows applications to disable the key guard |
| DUMP | Allows an application to retrieve state dump information |
| | from system services. |
| EXPAND_STATUS_BAR | Allows an application to expand or collapse the status bar. |
| FACTORY_TEST | Run as a manufacturer test application, running as the |
| | root user. |
| FLASHLIGHT | Allows access to the flashlight |
| FORCE_BACK | Allows an application to force a BACK operation on |
| | whatever is the top activity. |
| GET_ACCOUNTS | Allows access to the list of accounts in the Accounts |
| | Service |
| GET_PACKAGE_SIZE | Allows an application to find out the space used by any |
| | package. |
| GET_TASKS | Allows an application to get information about the currently |
| | or recently running tasks: a thumbnail representation of |
| | the tasks, what activities are running in it, etc. |
| GLOBAL_SEARCH | This permission can be used on content providers to allow |
| | the global search system to access their data. |
| HARDWARE_TEST | Allows access to hardware peripherals. |
| INJECT_EVENTS | Allows an application to inject user events (keys, touch, |
| | trackball) into the event stream and deliver them to ANY |
| | window. |
| INSTALL_LOCATION_PROVIDER | Allows an application to install a location provider into the |
| | Location Manager |
| INSTALL_PACKAGES | Allows an application to install packages. |
| INTERNAL_SYSTEM_WINDOW | Allows an application to open windows that are for use by |
| | parts of the system user interface. |
| INTERNET | Allows applications to open network sockets. |
| KILL_BACKGROUND_PROCESSES | Allows an application to kill a background process. |
| MANAGE_ACCOUNTS | Allows an application to manage the list of accounts in the |
| | account manager. |
| MANAGE_APP_TOKENS | Allows an application to manage (create, destroy, Z-order) |
| | application tokens in the window manager. |
| MASTER_CLEAR | Allows an application to perform a master clear operations |
| MODIFY_AUDIO_SETTINGS | Allows an application to modify global audio settings |
| MODIFY_PHONE_STATE | Allows modification of the telephony state - power on, |
| | mmi, etc. |
| MOUNT_FORMAT_FILESYSTEMS | Allows formatting file systems for removable storage. |
| MOUNT_UNMOUNT_FILESYSTEMS | Allows mounting and unmounting file systems for |
| | removable storage. |
| NFC | Allows applications to perform I/O operations over NFC |
| PROCESS_OUTGOING_CALLS | Allows an application to monitor, modify, or abort outgoing |
| | calls. |
| READ_CALENDAR | Allows an application to read the user's calendar data. |
| READ_CONTACTS | Allows an application to read the user's contacts data. |
| READ_FRAME_BUFFER | Allows an application to take screen shots and more |
| | generally get access to the frame buffer data |
| READ_HISTORY_BOOKMARKS | Allows an application to read (but not write) the user's |
| | browsing history and bookmarks. |
| READ_INPUT_STATE | Allows an application to retrieve the current state of keys |
| | and switches. |
| READ_LOGS | Allows an application to read the low-level system log files. |
| READ_PHONE_STATE | Allows read only access to phone state. |
| READ_SMS | Allows an application to read SMS messages. |
| READ_SYNC_SETTINGS | Allows applications to read the sync settings |
| READ_SYNC_STATS | Allows applications to read the sync stats |
| REBOOT | Required to be able to reboot the device. |
| RECEIVE_BOOT_COMPLETED | Allows an application to receive |
| | the ACTION_BOOT_COMPLETED that is broadcast after |
| | the system finishes booting. |
| RECEIVE_MMS | Allows an application to monitor incoming MMS |
| | messages, to record or perform processing on them. |
| RECEIVE_SMS | Allows an application to monitor incoming SMS messages, |
| | to record or perform processing on them. |
| RECEIVE_WAP_PUSH | Allows an application to monitor incoming WAP push |
| | messages. |
| RECORD_AUDIO | Allows an application to record audio |
| REORDER_TASKS | Allows an application to change the Z-order of tasks |
| SEND_SMS | Allows an application to send SMS messages. |
| SET_ACTIVITY_WATCHER | Allows an application to watch and control how activities |
| | are started globally in the system. |
| SET_ALARM | Allows an application to broadcast an intent to set an |
| | alarm for the user. |
| SET_ALWAYS_FINISH | Allows an application to control whether activities are |
| | immediately finished when put in the background. |
| SET_ANIMATION_SCALE | Modify the global animation scaling factor. |
| SET_DEBUG_APP | Configure an application for debugging. |
| SET_ORIENTATION | Allows low-level access to setting the orientation (actually |
| | rotation) of the screen. |
| SET_PROCESS_LIMIT | Allows an application to set the maximum number of (not |
| | needed) application processes that can be running. |
| SET_TIME | Allows applications to set the system time |
| SET_TIME_ZONE | Allows applications to set the system time zone |
| SET_WALLPAPER | Allows applications to set the wallpaper |
| SET_WALLPAPER_HINTS | Allows applications to set the wallpaper hints |
| SIGNAL_PERSISTENT_PROCESSES | Allow an application to request that a signal be sent to all |
| | persistent processes |
| STATUS_BAR | Allows an application to open, close, or disable the status |
| | bar and its icons. |
| SUBSCRIBED_FEEDS_READ | Allows an application to allow read access the subscribed |
| | feeds content provider. |
| SUBSCRIBED_FEEDS_WRITE | Allows an application to allow write access the subscribed |
| | feeds content provider |
| SYSTEM_ALERT_WINDOW | Allows an application to open windows using the |
| | type TYPE_SYSTEM_ALERT, shown on top of all other |
| | applications. |
| UPDATE_DEVICE_STATS | Allows an application to update device statistics. |
| USE_CREDENTIALS | Allows an application to request authentication tokens |
| | from the account manager |
| USE_SIP | Allows an application to use SIP service |
| VIBRATE | Allows access to the vibrator |
| WAKE_LOCK | Allows using power manager wake locks to keep |
| | processor from sleeping or screen from dimming |
| WRITE_APN_SETTINGS | Allows applications to write the APN settings |
| WRITE_CALENDAR | Allows an application to write (but not read) the user's |
| | calendar data. |
| WRITE_CONTACTS | Allows an application to write (but not read) the user's |
| | contacts data. |
| WRITE_EXTERNAL_STORAGE | Allows an application to write to external storage |
| WRITE_GSERVICES | Allows an application to modify the service map. |
| WRITE_HISTORY_BOOKMARKS | Allows an application to write (but not read) the user's |
| | browsing history and bookmarks. |
| WRITE_SECURE_SETTINGS | Allows an application to read or write the secure system |
| | settings. |
| WRITE_SETTINGS | Allows an application to read or write the system settings. |
| WRITE_SMS | Allows an application to write SMS messages. |
| WRITE_SYNC_SETTINGS | Allows applications to write the sync settings |

The data may be received by the mobile device over a network connection, e.g., originating from a computing device associated with an IT administrator. In other implementations, the data is input directly to the mobile device by the administrator, or is received when a disk image is copied to the mobile device, such as when the mobile device is initially set up or when a disk recovery operation is performed at the mobile device.

The computing device associated with the IT administrator may store multiple security policies, e.g. for different users, mobile devices, or other groupings. The mobile device may communicate identifying information to the computing device, which may select an appropriate security policy based on the identifying information and may communicate the appropriate security policy to the mobile device for installation. The process of selecting and communicating the appropriate security policy may occur fully automatically, e.g., without requiring the user of the mobile device to initiate communication, or without the user of the mobile device being aware of the communication, or the process may occur through one or more user interactions with the mobile device and/or administrator computing device by the user of the mobile device or the administrator. The computing device associated with the IT administrator may store the multiple security policies hierarchically, non-hierarchically, or some combination of both.

The pairings are used to generate data structures such as whitelists or blacklists for one or more of the permissions identified in the manifest. A restricted or blocked application may be placed on a blacklist for a corresponding permission, or may be removed or omitted from a whitelist for the corresponding permission. A “permit” or “allow” selection may result in the application being placed on a whitelist for a corresponding permission, or in the application being removed or omitted from a whitelist for the corresponding permission.

At step 220, the security application receives a request from a requesting application to perform one or more operations that are associated with the permission. For example, a security application may receive a request from the process manager, where the request identifies the desired functionality or permission to be invoked, and the application that is generating the request. In some implementations, the one or more of the operations may include an operation to access a particular process on the mobile device, an operation to access particular functionality of the mobile device, or an operation to access particular data stored on the mobile device.

At step 230, a determination is made by the security application to allow or block the request to perform the operations that are associated with the permission. The determination of whether to allow or block the request is referred to by this disclosure as “selective allowance” of the request. Determining whether to allow or block a request may include identifying a whitelist or blacklist associated with a currently active user account.

If the requesting application is included on a whitelist for the permission, or is not included on a blacklist for the permission, then at step 240 the requesting application is allowed to perform the operations. If, at step 230, the requesting applications is not included on a whitelist for the permission, or is included on a blacklist for the permission, then at step 250 the requesting application is blocked from performing the operations.

In some implementations, blocking the requesting application from performing the operations results in the occurrence of a fault. In response to this fault, the user could be shown an error message when an exception is thrown to the requesting application, and a report could be sent to an IT administrator. In response to the report, the IT administrator may decide to remove the requesting application from the mobile device. In other implementations, the occurrence of the fault may result in or contribute to the requesting application being automatically uninstalled.

In other implementations, blocking the requesting application from performing the operations may occur by returning dummy data, pseudo-random data, or default data to a requesting application. Alternatively, the requesting application may be temporarily blocked from performing the operations to allow an administrator to manually approve or disapprove the performance of the operations by the requesting application, through an administrative interface. If the administrator approves the performance of the operations, the requesting application is unblocked from performing the operations.

In some implementations, selectively allowing the requesting application to perform the operations may include allowing the requesting application to perform the operations based on determining that the requesting application is not identified in a pairing. For example, the security application 140 may be configured to let requesting applications run unimpeded unless the requesting application and the requested function are explicitly identified in a blacklist.

Selectively allowing the requesting application to perform the operations can also include disallowing the requesting application from performing the operations based on determining that the requesting application is not identified in a pairing. For example, the security application 140 may be configured to prevent any requesting application from accessing functions of the mobile device unless the requesting application and the requested function are explicitly identified in a whitelist.

In some implementations, for example when new software or a new version of software is released, the omission of an application on a whitelist or blacklist for a particular provision may trigger a process in which external review is sought from a user or device that is external to the mobile device. For example, a request to permit the requesting application to perform the operations can be communicated to an external device based on determining that the requesting application is not identified in the a pairing. The requesting application may be allowed to or prevented from performing the operations associated with a particular permission based on a response from the external device.

In some implementations, selectively allowing the requesting application to perform the operations can include allowing the requesting application to perform the operations based on determining that the requesting application is identified in the pairing (e.g., a whitelisted pairing). In some implementations, selectively allowing the requesting application to perform the operations can include disallowing the requesting application from performing the operations based on determining that the requesting application is identified in the pairing (e.g., a blacklisted pairing). In some implementations, selectively allowing the requesting application to perform the operations can include uninstalling the requesting application based on determining that the requesting application is not identified in the pairing (e.g., a blacklisted application).

In some implementations, the pairing may identify two or more applications. For example, the user may determine that two or more applications may conflict or compromise each other when both are installed on the same mobile device. In another example, an application may be purposely designed to obfuscate access to the mobile device's functionality and/or circumvent the process manager. In such examples, the pairing may include at least the identities of the two or more applications, and the process manager may use such pairings to prevent the two or more applications from being co-existing or executing on the mobile device.

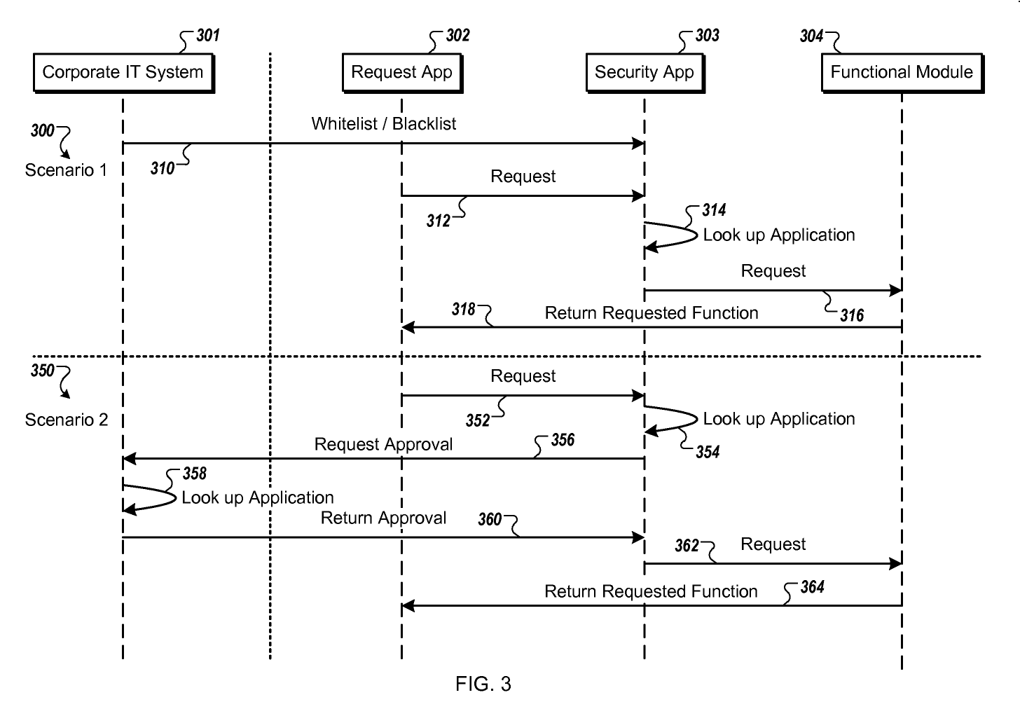

FIG. 3 is a timeline diagram that shows example interactions among systems for controlling access to information assets. In some implementations, the interactions of FIG. 3 may be performed by system 100 of FIG. 1. In a first scenario 300, a corporate IT system 301 provides pairings of applications and permissions at step 310, to be included in a whitelist or a blacklist. Alternatively, the IT administrator may define a whitelist or blacklist directly, and may send the whitelist or blacklist to the mobile device.

At step 312, a requesting application 302 sends a request to perform a particular function, to the security application 303. At step 314, the security application 303 identifies one or more permissions that are associated with the particular function, and looks for information that identifies the requesting application 144 in a whitelist or a blacklist associated with the particular permission. In FIG. 3, the security application 303 determines that the requesting application 302 is included on a whitelist for the particular permission or is not included on a blacklist for the particular permission, and thereby allows the requesting application 302 to access the requested function.

At step 316, the security application 303 relays the request to a functional module 304. At step 318, the functional module 304 returns information from the requested operation to the requesting application 302. For example, the functional module 304 may cause the mobile device to capture a digital audio using a microphone module, and return the digital audio to the requesting application 302.

A second scenario 350 generally describes a situation in which the requesting application is not included on a whitelist for a particular permission, and the mobile device requests access from an external entity to perform functions associated with the particular permission. Such a scenario may occur when, for example, an organization intends an IT administrator to have increased knowledge of or greater control over the applications that are installed on dual use devices. Determining whether the requesting application is identified in the whitelist may include selecting the whitelist that identifies the permission for the requested function from among multiple whitelists stored on the mobile device that identify various permissions.

At step 352, the requesting application 302 sends the request to perform a function associated with a particular permission, to the security application 303. At step 354, the security application 303 looks for the requesting application 302 in a whitelist associated with the particular permission, and fails to locate the requesting application 302 on the whitelist.

The security application 303 then sends a request 356 to the corporate IT system 301. The corporate IT system 301 responds to the request by determining, through automated or manual processes, whether the requesting application 302 should be allowed to perform the function associated with the particular permission. For example, the corporate IT system 301 may include a database that identifies permissions, and applications that are authorized or are not authorized to access functionality associated with each permission. In the example of FIG. 3, the corporate IT system 301 generates approval indicia in response to the request 356.

The corporate IT system 301 responds at step 360 by communicating the approval indicia to the security application 303. Based on receiving the approval indicia, the security application 303 determines that the request of step 352 is to be relayed to the functional module 304. At step 362, the requested function is sent to the functional module 304, and at step 364 the requested function is returned to the requesting application 302.

In some implementations, blacklists may be generated using crowdsourced data. For example, if a predetermined number of users have identified an application as being of low quality or as presenting an identified risk to IT assets, or if the identified application has been manually blacklisted by a predetermined number of users previously, then the security application may automatically blacklist the application as well.

In some implementations, an external signal can be used to add an application to a blacklist or to remove an application from a whitelist. For example, a malware identification organization may provide a list that identifies applications that contain malware, and such a list may be used to automatically populate a blacklist. In another example, an application developer may identify a potential vulnerability in his own application, and publish a notification that can be used by the security application to add the application to a blacklist, remove the application from a whitelist, or to selectively prohibit the vulnerable functions identified by the developer.

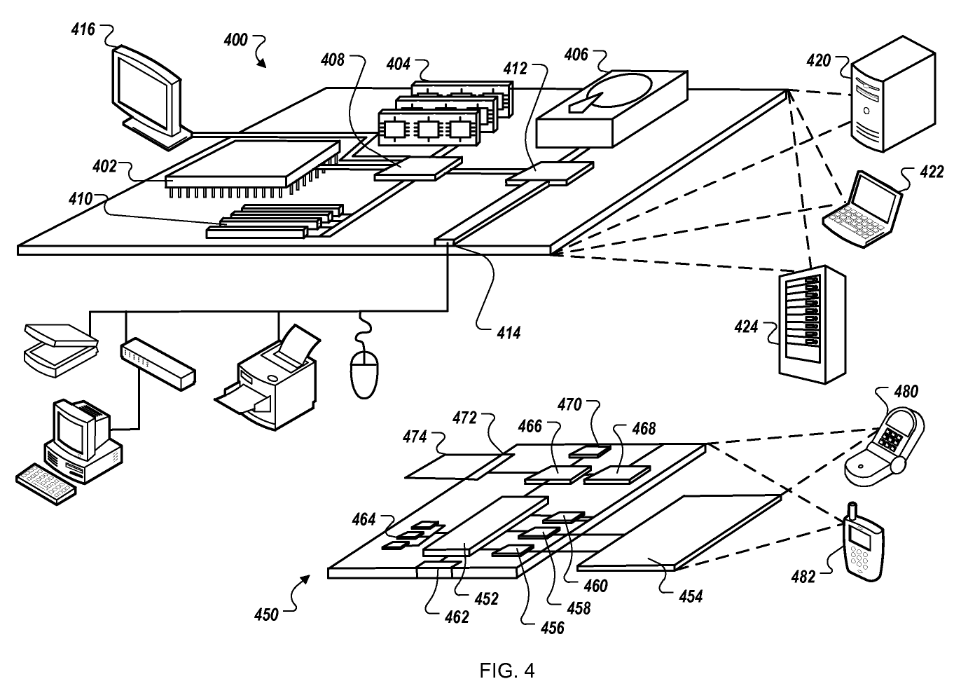

FIG. 4 is a block diagram of computing devices 400, 450 that may be used to implement the systems and methods described in this document, either as a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communication audibly using audio codec 460, which may receive spoken information from a user and convert it to usable digital information. Audio codex 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory,

Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A computer-implemented method comprising:
receiving, from an entity over a network and by a security application on a mobile device, a user-matched pairing that identifies a permission defined by an operating system of the mobile device, and one or more applications that are authorized to perform one or more operations that are associated with the permission;
generating or updating, by the security application, a whitelist for the permission based on the user-matched pairing, wherein the whitelist for the permission identifies the one or more applications as applications that are authorized to perform the one or more operations that are associated with the permission;
receiving, by the security application and during runtime of a requesting application, a request from application to perform the one or more operations that are associated with the permission;
determining, by the security application, that the requesting application is not identified in the whitelist for the permission;
transmitting, by the security application and to the entity over the network, a request to permit the requesting application to perform the one or more operations that are associated with the permission based on determining that the requesting application is not identified in the whitelist;
receiving, by the security application and from the entity over the network, a response to the request; and
allowing, by the security application, the requesting application to perform the one or more operations that are associated with the permission based on the response to the request.

2-4. (canceled)

5. The method of claim 1, wherein one or more of the operations that are associated with the permission comprises an operation to access a particular process on the mobile device, an operation to access particular functionality of the mobile device, or an operation to access particular data stored on the mobile device.

6. The method of claim 1, wherein the entity is a corporate information technology (IT) server.

7. The method of claim 1, wherein the pairing is received from a vendor associated with the requesting application.

8. The method of claim 1, wherein the pairing identifies the one or more applications by package name, application type, cryptographic signature, vendor name, or market-provided certification indicia.

9. The method of claim 1, wherein the whitelist for the permission is generated in part using crowdsourced data.

10-29. (canceled)

30. The method of claim 1, wherein the pairing further identifies a particular user from a group of users that shares the mobile device that is authorized to perform the one or more operations that are associated with the permission.

31. A system comprising:
one or more computers and one or more storage devices storing instructions that are operable, when executed by the one or more computers, to cause the one or more computers to perform operations comprising:
receiving, from an entity over a network and by a security application on a mobile device, a user-matched pairing that identifies a permission defined by an operating system of the mobile device, and one or more applications that are authorized to perform one or more operations that are associated with the permission;
generating or updating, by the security application, a whitelist for the permission based on the user-matched pairing, wherein the whitelist for the permission identifies the one or more applications as applications that are authorized to perform the one or more operations that are associated with the permission;
receiving, by the security application and during runtime of a requesting application, a request from the requesting application to perform the one or more operations that are associated with the permission;
determining, by the security application, that the requesting application is not identified in the whitelist for the permission;
transmitting, by the security application and to the entity over the network, a request to permit the requesting application to perform the one or more operations that are associated with the permission based on determining that the requesting application is not identified in the whitelist;
receiving, by the security application and from the entity over the network, a response to the request; and
allowing, by the security application, the requesting application to perform the one or more operations that are associated with the permission based on the response to the request.

32. The system of claim 31, wherein one or more of the operations that are associated with the permission comprises an operation to access a particular process on the mobile device, an operation to access particular functionality of the mobile device, or an operation to access particular data stored on the mobile device.

33. The system of claim 31, wherein the entity is a corporate information technology (IT) server.

34. The system of claim 31, wherein the pairing is received from a vendor associated with the requesting application.

35. The system of claim 31, wherein the pairing identifies the one or more applications by package name, application type, cryptographic signature, vendor name, or market-provided certification indicia.

36. The system of claim 31, wherein the whitelist for the permission is generated in part using crowdsourced data.

37. The system of claim 31, wherein the pairing further identifies a particular user from the group of users that is authorized to perform the one or more operations that are associated with the permission.

38. A computer-readable storage device storing software comprising instructions executable by one or more computers which, upon such execution, cause the one or more computers to perform operations comprising:
receiving, from an entity over a network and by a security application on a mobile device, a user-matched pairing that identifies a permission defined by an operating system of the mobile device, and one or more applications that are authorized to perform one or more operations that are associated with the permission;
generating or updating, by the security application, a whitelist for the permission based on the user-matched pairing, wherein the whitelist for the permission identifies the one or more applications as applications that are authorized to perform the one or more operations that are associated with the permission;
receiving, by the security application and during runtime of a requesting application, a request from the requesting application to perform the one or more operations that are associated with the permission;
determining, by the security application, that the requesting application is not identified in the whitelist for the permission;
transmitting, by the security application and to the entity over the network, a request to permit the requesting application to perform the one or more operations that are associated with the permission based on determining that the requesting application is not identified in the whitelist;
receiving, by the security application and from the entity over the network, a response to the request; and
allowing, by the security application, the requesting application to perform the one or more operations that are associated with the permission based on the response to the request.

39. The computer-readable storage device of claim 38, wherein one or more of the operations that are associated with the permission comprises an operation to access a particular process on the mobile device, an operation to access particular functionality of the mobile device, or an operation to access particular data stored on the mobile device.

40. The computer-readable storage device of claim 38, wherein the entity is a corporate information technology (IT) server.

41. The computer-readable storage device of claim 38, wherein the pairing is received from a vendor associated with the requesting application.

42. The computer-readable storage device of claim 38, wherein the pairing identifies the one or more applications by package name, application type, cryptographic signature, vendor name, or market-provided certification indicia.

43. The computer-readable storage device of claim 38, wherein the whitelist for the permission is generated in part using crowdsourced data.

44. The computer-readable storage device of claim 38, wherein the pairing further identifies a particular user from the group of users that is authorized to perform the one or more operations that are associated with the permission.

45. The method of claim 1, comprising updating, by the security application, the whitelist for the permission based on the response to the request.
